(19) United States
(12) Patent Application Publication
(10) Pub. No.: US 2025/0354596 A1
(43) Pub. Date: Nov. 20, 2025

(54) REVERSE SLAPPER HYDRAULIC BUMP STOP ASSEMBLY

(71) Applicant: Fox Factory, Inc., Duluth, GA (US)

(72) Inventor: Chadwick Joseph Kern, Three Rivers, MI (US)

(21) Appl. No.: 18/734,038

(22) Filed: Jun. 5, 2024

Related U.S. Application Data
(60) Provisional application No. 63/647,140, filed on May 14, 2024.

(51) Int. Cl. F16F 9/58; B60G 7/04

(52) U.S. Cl. CPC F16F 9/58; B60G 7/04; B60G 2204/127; B60G 2204/4502

(57) ABSTRACT

A reverse slapper hydraulic bump stop assembly for use in a vehicle includes an upper mounting bracket for affixing to a frame of a vehicle, a lower mounting bracket, a bell crank movably coupled to the upper mounting bracket, and a hydraulic bump stop assembly comprising a first end and a second end. The bell crank includes a bump surface configured to contact the upper mounting bracket. A first end of the hydraulic bump stop assembly is coupled to the lower mounting bracket, and a second end of the hydraulic bump stop assembly is coupled to the bell crank. The hydraulic bump stop assembly is oriented in a substantially vertical direction, such that directions of force do not need to be in line with lower control arm motion, and the assembly can be adjusted towards a front or rear of a vehicle based on a desired bump effect.

### CROSS-REFERENCE TO RELATED APPLICATION

This application claims the benefit of and priority to U.S. Provisional Patent Application No. 63/647,140 filed May 14, 2024, the contents of which being incorporated by reference in their entirety herein.

### TECHNICAL FIELD

The present disclosure generally relates to vehicle suspension systems, and more specifically to systems, methods, and devices for implementing and optimizing a reverse slapper-type hydraulic bump stop in a vehicle suspension system.

### BACKGROUND

Vehicle suspension systems are generally designed to absorb shocks and maintain contact between tires and a road, thereby enhancing safety, the comfort of the ride, and the vehicle's handling capabilities. Some suspension systems include a bump stop, which is a component designed to prevent the suspension from bottoming out, i.e., to prevent various suspension components from hitting each other when the suspension is fully compressed. Common bump stops are formed out of rubber and other elastic materials that compress or otherwise deform to prevent the various suspension components from contacting one another.

Hydraulic bump stops, on the other hand, can employ a hydraulic mechanism to absorb the energy from the suspension compression. The direction of the forces acting on the bump stop during suspension compression can affect the wear and tear of its components. For instance, multiple force directions can lead to seal and bearing wear on the bump stop. The surface on which the bump stop strikes also plays a role in its durability. For example, a horizontal striking surface can collect dirt, rocks, and debris, which can wear away the bump pad surface and impair the range of motion of the bump stop. Rocks and other debris can become lodged in hydraulic components, impairing the ability of the bump stop to operate as intended.

### BRIEF SUMMARY

According to an aspect of the present disclosure, a vehicle includes a lower control arm, a frame positioned above the lower control arm, and a reverse slapper hydraulic bump stop assembly. The assembly includes an upper mounting bracket affixed to the frame, a lower mounting bracket affixed to the lower control arm, a bell crank pivotably coupled to the upper mounting bracket, and a hydraulic member. The bell crank has a bump stop surface configured to contact the upper mounting bracket. The hydraulic member, having a first end and a second end, is oriented vertically relative to the lower control arm with its first end coupled to the lower mounting bracket and its second end coupled to the bell crank.

According to other aspects of the present disclosure, the vehicle may include one or more of the following features. The upper mounting bracket may be oriented on a front face of the frame and comprise a plurality of apertures. The bell crank may have a pivot rod and bearings positioned therein with respective ends mounted in the plurality of apertures, allowing the bell crank to pivotably mount to the upper mounting bracket about the pivot rod. The vehicle may further include a suspension device proximal to the reverse slapper hydraulic bump stop assembly that defines a ride height of the vehicle, distinct from the reverse slapper hydraulic bump stop assembly.

According to another aspect of the present disclosure, a hydraulic bump stop assembly includes an upper mounting bracket and a lower mounting bracket, a bell crank movably coupled to the upper mounting bracket, and a hydraulic member. The bell crank has a bump stop surface configured to contact the upper mounting bracket. The hydraulic member, having a first end and a second end, has its first end coupled to the lower mounting bracket and its second end coupled to the bell crank.

According to other aspects of the present disclosure, the hydraulic bump stop assembly may include one or more of the following features. The bell crank may further include a catch projecting from a surface of a housing of the bell crank, configured to contact the upper mounting bracket or a component attached thereto upon rotation to a predetermined orientation. The upper mounting bracket may be oriented on a front surface of the frame and comprise a plurality of side projections comprising apertures.

The lower mounting bracket may comprise a plurality of side projections comprising apertures. The hydraulic member may further comprise a cylinder housing, a piston, and a rod. The bell crank may comprise a triangular-shaped housing with an upper, inner surface and a lower, outer surface. The upper, inner surface may comprise a bump stop pad facing the upper mounting bracket. The lower, outer surface of the bell crank may comprise apertures having a pivot rod positioned therein, pivotably coupling a lower portion of the bell crank to the upper mounting bracket. The triangular-shaped housing may comprise notched-out areas recessed on side surfaces of the triangular-shaped housing.

In some aspects, a bottom end of the hydraulic member is not affixed to a lower control arm or other component of the vehicle. The bottom end of the hydraulic member includes a bottom bump surface sized and positioned to bump against or otherwise contact a respective surface of a lower component of the vehicle.

According to a further aspect of the present disclosure, a method includes determining a bell crank linkage motion ratio as a function of at least one of: a distance between an upper mounting bracket and a bell crank; a distance between a coupling point of the upper mounting bracket and a top of the bell crank; a distance between a top end of the bell crank and a bottom end of the bell crank; a distance between a lower mounting bracket and a bottom end of a hydraulic member; an overall height of the hydraulic bump stop assembly; and a position of the lower mounting bracket, for instance, on a lower control arm or other lower vehicle component. The hydraulic bump stop assembly thus can be provided in accordance with a desired bell crank linkage motion ratio.

According to other aspects of the present disclosure, the method may further include affixing the upper mounting bracket to the frame, and affixing the lower mounting bracket to a lower control arm. The method may further include adjusting the bell crank linkage motion ratio based on a desired bump-stop effect. The method may further include, in a first lower control arm compression stage, pivoting the bell crank about the upper mounting bracket until the bump stop pad contacts a striking surface of the upper mounting bracket. The method may further include, in a second lower control arm compression stage after the first lower control arm compression stage, compressing a hydraulic rod of the hydraulic member relative to a cylinder housing of the hydraulic member.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1 and 2 are perspective views of a vehicle having a slapper hydraulic bump stop assembly according to various embodiments of the present disclosure.

FIG. 3 is a perspective view of the slapper hydraulic bump stop assembly affixed to a lower control arm of the vehicle according to various embodiments of the present disclosure.

FIGS. 4 and 5 are enlarged perspective views of a first end of the slapper hydraulic bump stop assembly according to various embodiments of the present disclosure.

FIG. 6 is an enlarged perspective view of the first end of the slapper hydraulic bump stop assembly with a bell crank body omitted according to various embodiments of the present disclosure.

FIGS. 7 and 8 are perspective views of a bell crank of the slapper hydraulic bump stop assembly according to various embodiments of the present disclosure.

FIG. 9 is a perspective view of the slapper hydraulic bump stop assembly configured to float relative to a lower control arm of the vehicle according to various embodiments of the present disclosure.

FIG. 10 is a perspective view of a lower vehicle component showing various mounting locations for a bottom end of the slapper hydraulic bump stop assembly according to various embodiments of the present disclosure.

### DETAILED DESCRIPTION

The present disclosure relates to a reverse slapper hydraulic bump stop system (or “hydraulic bump stop system”) for enhancing the performance of a vehicle, particularly in relation to a vehicle suspension. The hydraulic bump stop system can be designed for optimum clearances and durability, among other criteria as will be described.

According to various embodiments, a slapper hydraulic bump stop assembly includes an upper mounting bracket, a lower mounting bracket, a bell crank, and a hydraulic member. The bell crank is movably coupled to the upper mounting bracket such that a bump stop pad positioned on the bell crank is configured to come into contact with a striking surface on the upper mounting bracket as the bell crank is rotated. The hydraulic member can have a first end coupled to the bell crank and a second end coupled to the lower mounting bracket.

The lower mounting bracket, in turn, can be affixed to a lower control arm of a vehicle suspension. As the frame of the vehicle is above the lower control arm of, the hydraulic member can be oriented vertically or, in other words, the hydraulic member can be oriented orthogonal to the frame and/or the lower control arm. The hydraulic bump stop assembly allows suspension forces to travel transversely therethrough due to the presence of eye mounts on each end. The rotation of the control arm can result in a singular force direction on the bump stop, preventing seal wear and other degradation of the system. Moreover, the slapping or bumping motion occurs against the frame as opposed to a lower control arm.

Without deviating from the scope of the present disclosure, the foregoing components of the slapper hydraulic bump stop assembly can be sized and positioned or otherwise modified to adjust a bell crank linkage motion ratio of bump stop compression and/or suspension compression. As such, a bell crank linkage motion ratio of the slapper hydraulic bump stop assembly can be customized to enable bump stop force directions to be adjusted, allowing a position of the system to be moved towards a front or a rear of a vehicle depending on a desired vehicle, vehicle configuration, and/or implementation.

In some cases, the slapper hydraulic bump stop assembly can be mounted on the frame end of the vehicle. This positioning can allow for a change in the bump stop force direction, which does not necessarily have to align with the motion of the lower control arm. Depending on the packaging, the force direction can be directed towards the front or rear of the vehicle. The slapper hydraulic bump stop assembly can also include a striking surface that is vertical, as opposed to the traditional horizontal orientation. This may offer the benefit of preventing damage to the bump pad from rocks and dirt that may collect on the lower control arm.

Furthermore, the slapper hydraulic bump stop assembly can be configured to pivot the bell crank about the upper mounting bracket until the bump stop pad contacts a striking surface of the upper mounting bracket. This action can occur in a first lower control arm compression stage. In a subsequent second lower control arm compression stage, the hydraulic rod of the hydraulic member can compress relative to a cylinder housing of the hydraulic member. Overall, the slapper hydraulic bump stop assembly can provide a more robust and efficient suspension system for a vehicle, improving the vehicle's performance and durability.

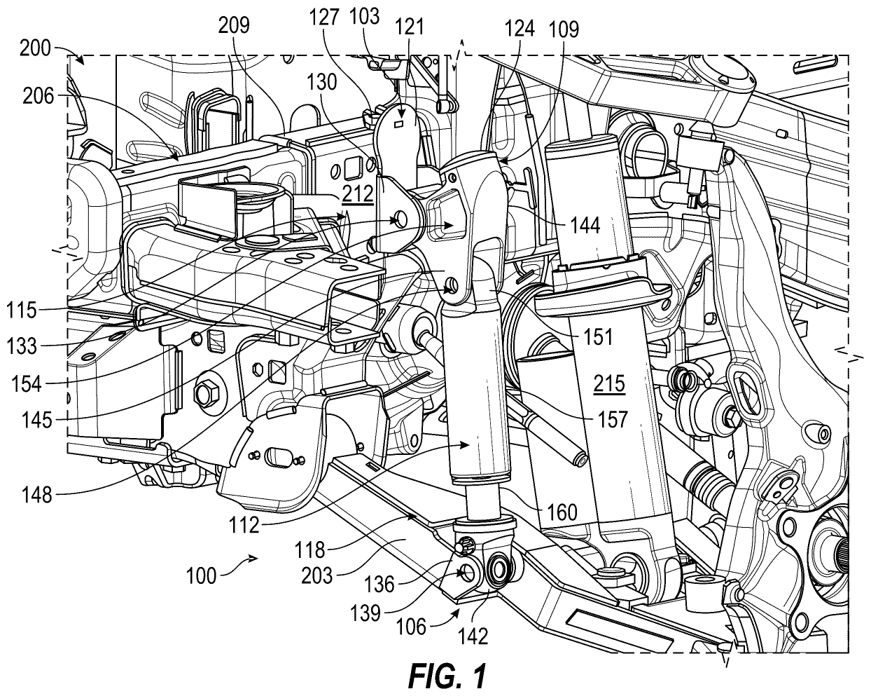

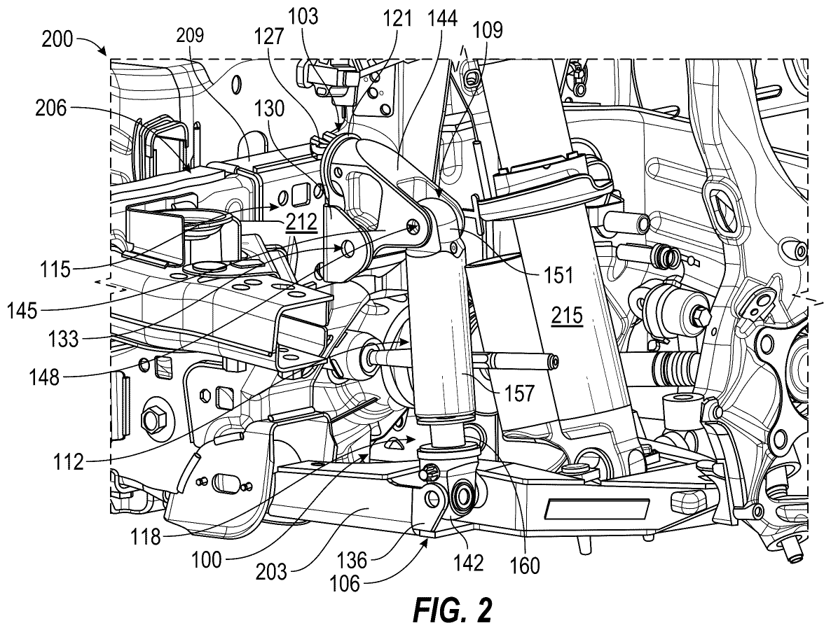

Referring to FIGS. 1 and 2, perspective views of a slapper hydraulic bump stop assembly 100 installed on a vehicle 200 are shown with various components of the vehicle 200 omitted for explanatory purposes, as can be appreciated. The slapper hydraulic bump stop assembly 100 (or “hydraulic bump stop assembly 100”) can be, in some implementations, positioned on a front end of the vehicle 200. However, in alternative implementations, the hydraulic bump stop assembly 100 can be positioned on a rear end of the vehicle 200. Generally, the hydraulic bump stop assembly 100 includes an upper mounting bracket 103, a lower mounting bracket 106, a bell crank 109, and a hydraulic member 112. The hydraulic member 112 has a first end 115 (e.g., a top end) movably coupled to the bell crank 109 and a second end 118 (e.g., a bottom end) movably coupled to the lower mounting bracket 106. The hydraulic member 112 can include a hydraulic shock in some implementations.

The upper mounting bracket 103 includes a striking surface 121, where the bell crank 109 is configured to strike or otherwise contact the striking surface 121. The striking surface 121 in some embodiments can include a substantially planar surface elongated vertically across a front surface 212 of the frame 206. Based on movement of a lower control arm 203 of the vehicle 200, a bump stop pad 124 positioned on the bell crank 109 will “slap” or contact the striking surface 121 of the upper mounting bracket 103. Contact between the bell crank 109 and the striking surface 121 prevents further vertical translation of the hydraulic member 112, as will be described in greater detail below.

The upper mounting bracket 103 is configured to affix to a frame 206 of the vehicle 200 in some implementations. For instance, the frame 206 of the vehicle 200 can include a rectangular cross-member (also referred to as front and rear cross-members) or like device having at least a top surface 209 and a front surface 212 facing a front of the vehicle 200. It is understood, however, that other shaped frame surfaces can be utilized, as well as other parts of the frame 206, such as the wheelhouse. In the example depicted, the upper mounting bracket 103 can be affixed to the top surface 209 and/or the front surface 212 such that the striking surface 121 of the upper mounting bracket 103, or a back surface of the upper mounting bracket 103, is oriented on the front surface 212 of the frame 206. When the bell crank 109 comes into contact with the upper mounting bracket 103, potentially with great force, the force is dissipated across the front surface 212 of the frame 206.

The upper mounting bracket 103 can include a mounting tab 127 extending orthogonally from a rear face of the striking surface 121, where the rear face contacts the front surface 212 of the frame 206. The mounting tab 127 can include an aperture (not shown) for mounting the upper mounting bracket 103 to the top surface 209 of the frame 206. Further, the upper mounting bracket 103 can include upper bracket side projections 130 projecting from sides of the striking surface 121. The striking surface 121 can be positioned between the upper bracket side projections 130.

In some embodiments, the upper bracket side projections 130 are integral with the striking surface 121 and, as such, in some embodiments, the upper mounting bracket 103 can be formed of a single component through a forming, stamping, shearing, and bending or like process. Alternatively, the upper bracket side projections 130 can be welded or otherwise permanently affixed to the striking surface 121.

The upper bracket side projections 130 can include apertures 133 used to pivotably couple the bell crank 109 to the upper mounting bracket 103. The assembly can include one or more bolts, pins, rods, bushings, bearings, washers, springs, or other like devices (not shown) that extend through the apertures 133 and the bell crank 109, to pivotably couple a bottom portion of the bell crank 109 to the upper mounting bracket 103. In some embodiments, a rod can be provided having ends positioned in respective apertures 133, allowing the bell crank 109 to rotate about the rod and the apertures 133.

The lower mounting bracket 106 is configured to affix to the lower control arm 203 of the vehicle 200, as shown in FIGS. 1 and 2. In some embodiments, the lower mounting bracket 106 is fixed with the lower control arm 203, such that the lower mounting bracket 106 moves with the lower control arm 203. The lower mounting bracket 106 can be affixed to the lower control arm 203 using one or more bolts, welds, and so forth, although other forms of connections can be employed. The lower mounting bracket 106 includes lower bracket side projections 136 that, like the upper bracket side projections 130, can include one or more apertures 139. A lower end of the hydraulic member 112 can thus be mounted to the lower mounting bracket 106 by nesting a distal portion 142 of the second end 118 within the lower bracket side projections 136 and routing a bolt or like device through an eyelet (not shown) of the hydraulic member 112 and the apertures 139. A nut (not shown) or other suitable connection device can retain the bolt and the hydraulic member 112 in a nested arrangement between the lower bracket side projections 136.

Thus, the second end 118 of the hydraulic member 112 will move in accordance with the lower control arm 203. In other words, as the lower control arm 203 moves up (i.e., compresses), the second end 118 of the hydraulic member 112 will similarly move up with the lower control arm 203 and, as the lower control arm 203 moves down (i.e., decompresses), the second end 118 of the hydraulic member 112 will move down with the lower control arm 203.

The bell crank 109 can include a bell crank body 144 configured to pivotably couple to the upper mounting bracket 103. The bell crank body 144 can include a generally triangular housing that includes member mounting projections 145 defining a vertex having member mounting apertures 148 disposed therein. To this end, an upper end of the hydraulic member 112 can be mounted to the upper mounting bracket 103 by nesting a proximal portion 151 of the hydraulic member 112 within the member mounting projections 145 and routing a bolt or like device through an eyelet (not shown) on a proximal portion 151 of the hydraulic member 112 and the member mounting apertures 148. A nut (not shown) or other suitable connection device can retain the hydraulic member 112 in a nested arrangement between the member mounting projections 145.

The bell crank body 144 can be formed out of a relatively lightweight but strong material sufficient to withstand compressive and tensile stresses due to large forces. In some embodiments, the bell crank body 144 can be formed of 6061 aluminum or like material, whereas the bump stop pad 124 can be formed of rubber or other deforming or force-dampening material.

In some embodiments, the bell crank body 144 includes notched-out areas 154 that are recessed with respect to sidewalls of the bell crank body 144. The notched-out areas 154 can reduce the amount of material required to form the bell crank 109 without impairing the structural integrity of the bell crank 109, can make the bell crank 109 easier to manufacture, and so forth. The notched-out areas 154 are shown as being positioned on sidewalls of the bell crank body 144 in FIGS. 1 and 2, but the notched-out areas 154 can be provided in alternative or additional locations in some cases.

The hydraulic member 112 can include a cylinder housing 157, a hydraulic rod 160 movably positioned in the cylinder housing 157, a piston (not shown) coupled to the hydraulic rod 160 internal to the cylinder housing 157, and other hydraulic components not described in detail herein. The hydraulic member 112, in the arrangement of FIG. 1, is in an extended state, whereby the hydraulic rod 160 is extended from the cylinder housing 157. The hydraulic rod 160 is in the extended state until the lower control arm 203 moves upward, causing the bell crank 109 to pivot relative to the upper mounting bracket 103 until the bump stop pad 124 contacts the striking surface 121 of the upper mounting bracket 103. Thereafter, the hydraulic rod 160 will translate relative to the cylinder housing 157 based on movement of the lower control arm 203. Such configuration prevents bottoming out of the vehicle 200. In other words, the configuration prevents various suspension components from hitting each other when the suspension is fully compressed.

While FIG. 1 shows the hydraulic bump stop assembly 100 at full extension where the lower control arm 203 is titled or angled downwards relative to the frame 206, FIG. 2, on the other hand, shows the hydraulic bump stop assembly 100 in a compressed or collapsed position when the lower control arm 203 pivots upward relative to the frame 206. The hydraulic bump stop assembly 100 thus has multiple stages of compression and extension. Generally, as the lower control arm 203 of the vehicle 200 compresses (or moves upward), the bell crank 109 will rotate towards the frame 206 until the bump stop pad 124 contacts the striking surface 121 of the upper mounting bracket 103, which prevents further rotation of the bell crank 109.

As shown in FIG. 2, upon nearly a full rotation in a first stage of compression, the bell crank 109 is oriented parallel to the upper mounting bracket 103 and the front surface 212 of the frame 206, and an interior surface of the bell crank 109 is flush or nearly flush with the striking surface 121. At this time, the hydraulic member 112 will begin to compress, acting as a second stage of compression.

The particular configuration and orientation of the hydraulic bump stop assembly 100 places the contact point higher on the vehicle 200 to prevent damage to the bump stop pad 124 while keeping the components of the hydraulic bump stop assembly 100 higher and out of the way. Moreover, as the striking surface 121 is positioned on the upper mounting bracket 103 which is, in turn, positioned along a horizontal part of the frame 206, the striking of the bump stop pad 124 against the striking surface 121 will transfer force into the frame 206, a generally robust and solid structure.

The vehicle 200 can further include a suspension device 215. As shown in FIGS. 1 and 2, the suspension device 215 is distinct and separate from the slapper hydraulic bump stop assembly 100. The suspension device 215 can include a suspension system that sets the ride height of the vehicle 200. In contrast, the hydraulic bump stop assembly 100 does not set the ride height of the vehicle 200, but, instead, prevents the vehicle 200 from bottoming out. As such, the suspension device 215 can include a shock, a coil spring, a leaf spring, an air spring, a torsion bar, a strut, an air suspension system, a pneumatic or hydropneumatic suspension, or any combination thereof. Each of these devices can be used to set or adjust the ride height of a vehicle, either through manual adjustment or by design of the suspension system itself. Moreover, the suspension device 215 can set the bottom out limit on the hydraulic bump stop assembly 100.

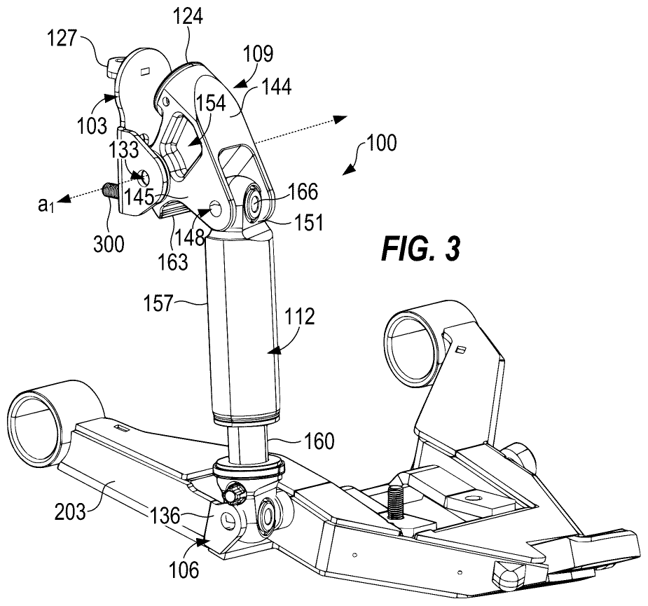

Turning now to FIG. 3, a front perspective view of the hydraulic bump stop assembly 100 is shown being coupled to the lower control arm 203 of the vehicle 200. Generally, various components of the vehicle 200 other than the lower control arm 203 coupled to the lower mounting bracket 106 are omitted from view for explanatory purposes. The bell crank 109 is shown pivoting about an axis a₁, which can be parallel to a rod (not shown) that can movably couple the bell crank 109 to the upper mounting bracket 103.

The bell crank body 144 shows the member mounting projections 145 being positioned on a bottom end of the housing opposite that of the bump stop pad 124 that is positioned on a top end of the housing. The bell crank body 144 can further include a catch 163 positioned on the bottom end of the bell crank body 144 on an internal side opposite that of the member mounting projections 145. The catch 163 can be integrally formed with the bell crank body 144.

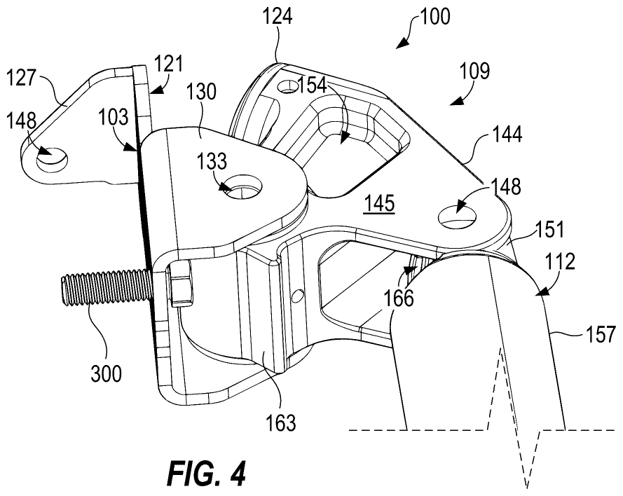

The upper mounting bracket 103 can be affixed to the frame 206 via one or more bolts 300, welds, nut tabs, or like connection devices. It is understood that bolts 300 can be used to connect the upper mounting bracket 103 and/or the lower mounting bracket 106 to the frame 206 by insertion through one or more apertures 149 which may be, in turn, bolted or otherwise affixed to the frame 206, lower control arm 203, or other suitable vehicle location. In instances when a bolt 300 or like connection device is utilized, the bolt 300 can project beyond a surface of the striking surface 121 of the upper mounting bracket 103, as shown in FIG. 4. Referring collectively to FIGS. 3 and 4, the catch 163 can include a projection extending from the bell crank body 144. In some embodiments, the catch 163 includes a triangular-shaped projection extending from a bottom, inner end of the bell crank body 144.

In some instances, the lower control arm 203 of the vehicle 200 can extend or lower suddenly, which can cause the bell crank 109 to pivot away from the upper mounting bracket 103, and the hydraulic member 112 to extend quickly. Such extension can cause the bell crank 109 to over-rotate and impose significant force on the vehicle suspension, which can cause damage to the hydraulic bump stop assembly 100. In order to prevent an over-rotation, the catch 163 comes into contact with the bolt 300 or like device and prevents any additional rotation of the bell crank 109 downwards.

An upper end of the hydraulic member 112 can be mounted to the upper mounting bracket 103 by nesting a proximal portion 151 of the hydraulic member 112 within the member mounting projections 145 and routing a bolt or like device through an eyelet (not shown) on a proximal portion 151 of the hydraulic member 112 and the member mounting apertures 148. A nut (not shown) or other suitable connection device can retain the hydraulic member 112 in a nested arrangement between the member mounting projections 145.

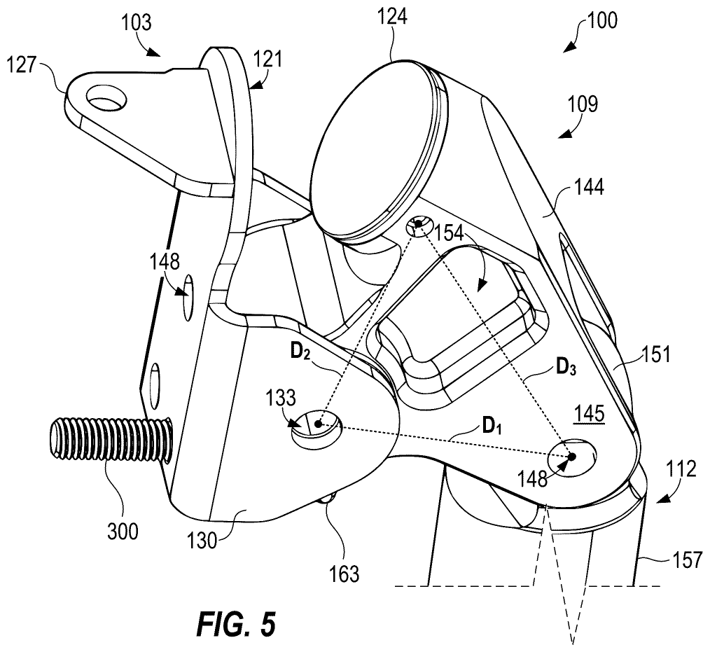

FIGS. 4 and 5 further illustrate the upper end of the hydraulic member 112 being mounted to the upper mounting bracket 103. A proximal portion 151 of the hydraulic member 112 is shown as being nested within the member mounting projections 145 and routing a bolt (not shown) or like device through an eyelet 166 on a proximal portion 151 of the hydraulic member 112 and the member mounting apertures 148. A nut (not shown) or other suitable connection device can retain the hydraulic member 112 in a nested arrangement between the member mounting projections 145 through coupling with the bolt or like connection device.

A desired bell crank linkage motion ratio, which can affect the ride quality of the vehicle 200, can be determined as a function of at least one of a distance between the upper mounting bracket 103 and a bell crank 109, denoted distance D₁; a distance between a coupling point of the upper mounting bracket 103 and a top of the bell crank 109, denoted distance D₂; a distance between a top end of the bell crank 109 and a bottom end of the bell crank 109, denoted distance D₃; a distance between a lower mounting bracket 106 and a bottom end of a hydraulic member 112 (not shown); and an overall height of a hydraulic bump stop assembly 100. The hydraulic bump stop assembly 100 thus can be provided in accordance with a desired bell crank linkage motion ratio.

For instance, by decreasing distances D₁, D₂, and/or D₃, contact between the bump stop pad 124 and the striking surface 121 is engaged more quickly during vehicle operation. In contrast, by increasing distances D₁, D₂, and/or D₃, contact between the bump stop pad 124 and the striking surface 121 is engaged more slowly during vehicle operation. It may be desirable for the bump stop pad 124 to be contacted with the striking surface 121 a last predetermined percentage of wheel travel, such as 20%, 30%, 40%, 50%, and so forth, for example.

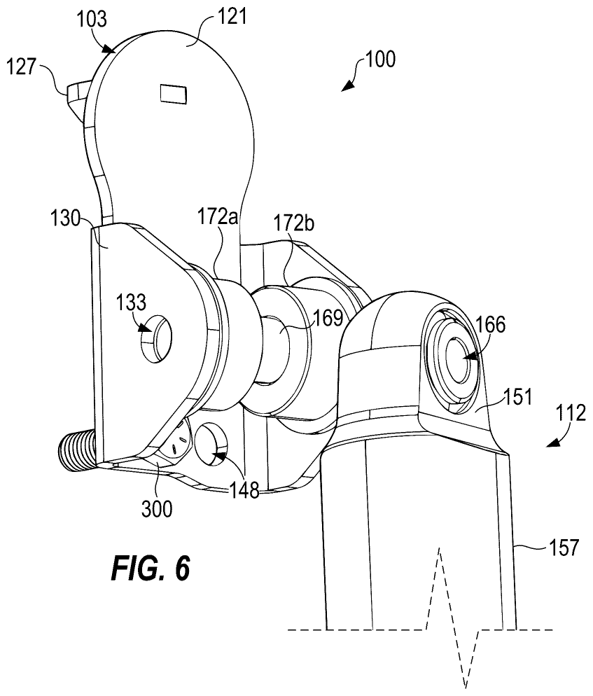

Referring now to FIG. 6, a perspective view of the hydraulic bump stop assembly 100 is shown with the bell crank 109 omitted for explanatory purposes. The hydraulic bump stop assembly 100 further includes a pivot rod 169 and one or more bushings 172a, 172b (collectively “bushings 172”). The pivot rod 169 can include distal ends positioned in respective apertures 133 of the upper bracket side projections 130 such that the pivot rod 169 and/or the bushings 172 rotate about the axis a₁. In some implementations, the pivot rod 169 and/or the bushings 172 are part of the bell crank body 144 although, in alternative embodiments, the pivot rod 169 and/or the bushings 172 can be separate from the bell crank 109 and the bell crank body 144 thereof. The bushings 172 can include bearings in some embodiments. The bushings 172 can include polyurethane bushings in some embodiments, and the pivot rod 169 and/or the bushings 172 can be greased in some implementations.

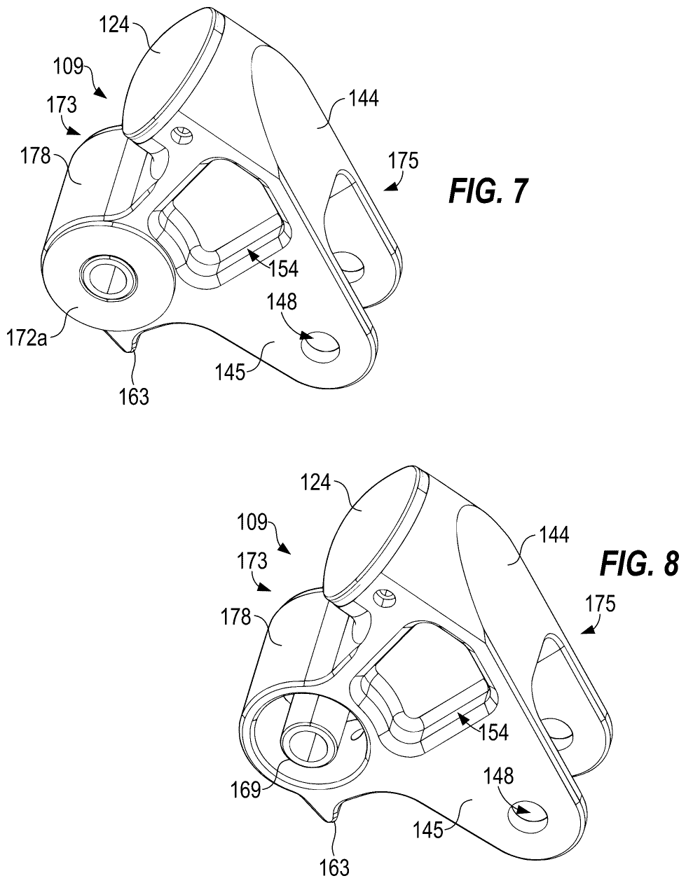

Moving along, FIGS. 7 and 8 show side perspective views of the bell crank 109. The bell crank 109 includes the bell crank body 144. The bell crank body 144 has an inner surface 173 facing away from a front of a vehicle, and an outer surface 175 facing a front of a vehicle. The bump stop pad 124 can be positioned on a top end of the inner surface 173 of the bell crank body 144. In some embodiments, the bell crank body 144 includes a circular chamber 178 on a lower end of the inner surface 173 that can project therefrom, defining a curved edge that assists with pivotal rotation of the bell crank 109. The circular chamber 178 can include bushings 172 (e.g., bushing 172a and/or bushing 172b), the pivot rod 169, and/or other components disposed therein. The catch 163 can be positioned on a bottom-most section of the chamber 178.

The bell crank body 144 can be somewhat triangular, where member mounting projections 145 extend towards a lower end of the outer surface 175, acting as a vertex of the triangle. Each of the member mounting projections 145 can include one or more member mounting apertures 148. Thus, the upper end of the hydraulic member 112 can be mounted to the upper mounting bracket 103 by nesting a proximal portion 151 of the hydraulic member 112 within the member mounting projections 145 and routing a bolt or like device through the proximal portion 151 of the hydraulic member 112 and respective member mounting apertures 148.

Referring back to FIGS. 1 and 2, in some embodiments, the hydraulic member 112 and the bell crank 109 can be oriented substantially vertically relative to a horizontal ground surface or a horizontally-oriented lower control arm 203, such as 90° (±20 degrees). Thus, the hydraulic member 112 and the bell crank 109 can be oriented substantially orthogonal to the horizontal ground surface or the horizontally-oriented lower control arm 203.

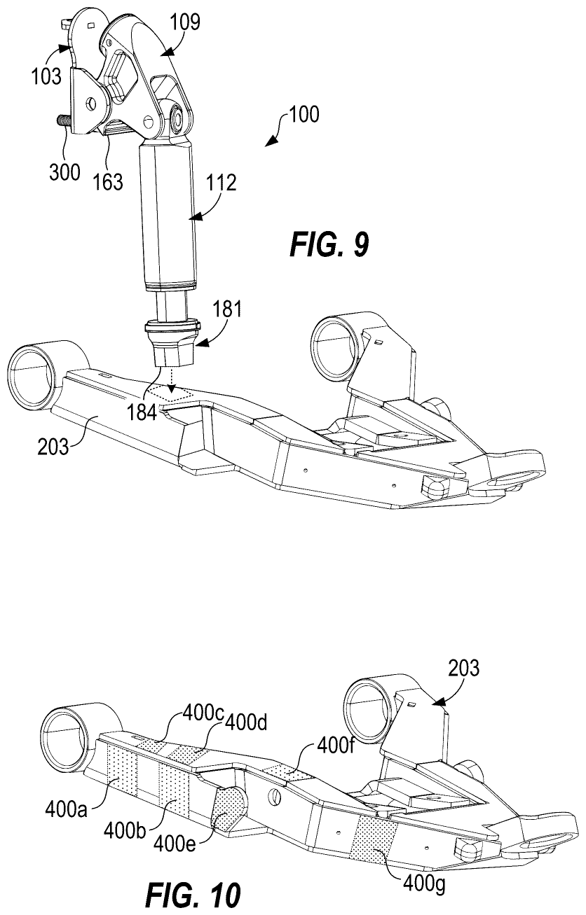

FIG. 9 is a perspective view of an alternative embodiment of the slapper hydraulic bump stop assembly 100. While various embodiments described herein include a lower mounting bracket 106 fixedly attached to a lower end of the hydraulic member 112, in some embodiments, the hydraulic member 112 may not couple directly or be fixed to the lower control arm 203 (or other lower component) of the vehicle 200. To this end, the hydraulic member 112 may float relative to the lower control arm 203 or, in other words, the hydraulic member 112 is not affixed to the lower control arm 203. For instance, in some embodiments, a lower distal end 181 of the hydraulic member 112 may include a bottom bump surface 184 configured to bump against the lower control arm 203 as the lower control arm 203 compresses.

Once the bottom bump surface 184 contacts the lower control arm 203, the bump stop assembly 100 while operate as described above. Once the lower control arm 203 lowers or decompresses, the hydraulic member 112 and the bell crank 109 will release and lower, and separation will be provided between the bottom bump surface 184 and the lower control arm 203. The catch 163 of the bell crank body 144 can maintain a vertical orientation or position of the bump stop assembly 100, for instance, by contacting a bolt 300 or other component. Such orientation can prevent the bump stop assembly 100 from rotating out of alignment with the lower control arm 203 or other desired vehicle component. It is understood, however, that the bell crank 109 and/or the upper mounting bracket 103 may include additional components to retain an orientation of the bump stop assembly 100 and prevent out-of-alignment conditions, over-rotations, and the like.

Turning now to FIG. 10, a perspective view of a lower vehicle component (e.g., a lower control arm 203) is shown according to various embodiments. The lower vehicle component can include a multitude of mounting locations 400a . . . 400g (collectively “mounting locations 400”). While various embodiments described herein show a particular mounting location 400e (e.g., at a corner of two members of the lower control arm 203), there are potentially a multitude of mounting locations 400 for a bottom end of the slapper hydraulic bump stop assembly 100.

For instance, mounting locations 400 can be positioned on lateral surfaces of the lower control arm 203, upper surfaces of the lower control arm 203, and so forth. In some embodiments, each mounting location 400 includes installed brackets 403, providing a technician or other personnel a multitude of options in affixing the bottom end of the bump stop assembly 100. Alternatively, the technician can weld or otherwise install brackets at the desired mounting location 400. Along with tuning a motion ratio of the bump stop assembly 100 based on a size, dimensions, and orientation of the bell crank 109, the mounting locations 400 allow tuning of the influence of the bump stop assembly 100 at full compression, and so forth. Again, while various embodiments described herein show a lower control arm 203, the disclosure is not so limited, and other lower components of a vehicle 200 can be utilized.

The features, structures, or characteristics described above can be combined in one or more embodiments in any suitable manner, and the features discussed in the various embodiments can be interchangeable, if possible. In the following description, numerous specific details are provided in order to fully understand the embodiments of the present disclosure. However, a person skilled in the art will appreciate that the technical solution of the present disclosure can be practiced without one or more of the specific details, or other methods, components, materials, and the like can be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components can be referred to as a “first” component, a “second” component, and so forth, to the extent applicable.

The above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, the following is claimed:

1. A vehicle, comprising:
a lower control arm;
a frame positioned above the lower control arm; and
a reverse slapper hydraulic bump stop assembly, comprising:
an upper mounting bracket affixed to the frame;
a lower mounting bracket affixed to the lower control arm;
a bell crank pivotably coupled to the upper mounting bracket, the bell crank comprising a bump stop surface configured to contact the upper mounting bracket; and
a hydraulic member having a first end and a second end, wherein the first end of the hydraulic member is coupled to the lower mounting bracket, and the second end of the hydraulic member is coupled to the bell crank, wherein the hydraulic member is oriented vertically relative to the lower control arm.

2. The vehicle according to claim 1, wherein the upper mounting bracket is oriented on a front face of the frame, the upper mounting bracket comprises a plurality of apertures, and the bell crank has a pivot rod and bushings positioned therein having respective ends mounted in the plurality of apertures, the bell crank being pivotably mounted to the upper mounting bracket about the pivot rod.

3. The vehicle according to claim 1, further comprising a suspension device proximal to the reverse slapper hydraulic bump stop assembly that defines a ride height of the vehicle, the suspension device being different and distinct from the reverse slapper hydraulic bump stop assembly.

4. A hydraulic bump stop assembly, comprising:
an upper mounting bracket, the upper mounting bracket being configured to affix to a frame of a vehicle;
a bell crank movably coupled to the upper mounting bracket, the bell crank comprising a bump stop surface configured to contact the upper mounting bracket; and
a hydraulic member comprising a first end and a second end, wherein the second end of the hydraulic member is coupled to the bell crank.

5. The hydraulic bump stop assembly according to claim 4, wherein the bell crank further comprises a catch projecting from a surface of a housing of the bell crank, the catch being configured to contact the upper mounting bracket or a component attached thereto upon rotation to a predetermined orientation that prevents an over-rotation of the bell crank relative to the upper mounting bracket.

6. The hydraulic bump stop assembly according to claim 4, wherein:
the hydraulic bump stop assembly further comprises a lower mounting bracket, the first end of the hydraulic member being coupled to the lower mounting bracket;
the upper mounting bracket is oriented on a front surface of the frame;
the upper mounting bracket comprises a plurality of side projections comprising apertures, the first end of the hydraulic member comprising an eyelet for coupling the hydraulic member to the upper mounting bracket via the eyelet and the apertures; and
the lower mounting bracket comprises a plurality of side projections comprising apertures, the first end of the hydraulic member comprising an eyelet for coupling the hydraulic member to the lower mounting bracket via the eyelet and the apertures.

7. The hydraulic bump stop assembly according to claim 4, wherein the upper mounting bracket comprises a striking surface and a mounting tab oriented orthogonal to the striking surface, wherein the mounting tab is configured to affix to a top surface of the frame and a rear surface of the upper mounting bracket opposite the striking surface is configured to affix to the front surface of the frame.

8. The hydraulic bump stop assembly according to claim 4, wherein the hydraulic member further comprises a cylinder housing, a piston, and a rod.

9. The hydraulic bump stop assembly according to claim 4, wherein the bell crank comprises a triangular-shaped housing comprising an upper, inner surface and a lower, outer surface, wherein the upper, inner surface comprises a bump stop pad facing the upper mounting bracket.

10. The hydraulic bump stop assembly according to claim 9, wherein the lower, outer surface of the bell crank comprises apertures having a pivot rod positioned therein, the pivot rod pivotably coupling a lower portion of the bell crank to the upper mounting bracket.

11. The hydraulic bump stop assembly according to claim 9, wherein the triangular-shaped housing comprises notched-out areas recessed on side surfaces of the triangular-shaped housing.

12. The hydraulic bump stop assembly according to claim 4, wherein the bump stop assembly defines a bell crank motion ratio determined as a function of at least one of: a distance between an upper mounting bracket and a bell crank; a distance between a coupling point of the upper mounting bracket and a top of the bell crank; a distance between a top end of the bell crank and a bottom end of the bell crank; a distance between a lower mounting bracket and a bottom end of a hydraulic member; an overall height of the hydraulic bump stop assembly; and a position of the lower mounting bracket.

13. The hydraulic bump stop assembly according to claim 4, wherein the bump stop pad is configured to contact a striking surface of the upper mounting bracket, where a rear surface of the upper mounting bracket opposite the striking surface is affixed to a front face of the frame such that force is distributed along the front face of the frame.

14. The hydraulic bump stop assembly according to claim 4, wherein the hydraulic bump stop assembly is configured to, in a first lower control arm compression stage, pivot the bell crank about the upper mounting bracket until the bump stop pad contacts a striking surface of the upper mounting bracket.

15. The hydraulic bump stop assembly according to claim 14, wherein the hydraulic bump stop assembly is configured to, in a second lower control arm compression stage after the first lower control arm compression stage, compress a hydraulic rod of the hydraulic member relative to a cylinder housing of the hydraulic member.

16. The hydraulic bump stop assembly according to claim 14, wherein the first end of the hydraulic member comprises a bottom bump surface sized and positioned to bump against a lower component of the vehicle.

17. A method, comprising:
determining a bell crank linkage motion ratio as a function of at least one of: a distance between an upper mounting bracket and a bell crank; a distance between a coupling point of the upper mounting bracket and a top of the bell crank; a distance between a top end of the bell crank and a bottom end of the bell crank; a distance between a lower mounting bracket and a bottom end of a hydraulic member; an overall height of the hydraulic bump stop assembly; and a position of the lower mounting bracket;
providing the hydraulic bump stop assembly in accordance with the bell crank linkage motion ratio, the hydraulic bump stop assembly comprising the upper mounting bracket, the lower mounting bracket, the bell crank, and the hydraulic member, wherein:
the bell crank is movably coupled to the upper mounting bracket,
the bell crank comprises a bump stop surface configured to contact the upper mounting bracket, and
the hydraulic member comprises a first end and a second end, the first end of the hydraulic member being coupled to the lower mounting bracket, and the second end of the hydraulic member being coupled to the bell crank.

18. The method of claim 16, further comprising affixing the upper mounting bracket to the frame, and affixing the lower mounting bracket to a lower control arm.

19. The method of claim 16, further comprising adjusting the bell crank linkage motion ratio based on a desired bump-stop effect.

20. The method according to claim 16, further comprising:
in a first lower control arm compression stage, pivoting the bell crank about the upper mounting bracket until the until the bump stop pad contacts a striking surface of the upper mounting bracket; and
in a second lower control arm compression stage after the first lower control arm compression stage, compressing a hydraulic rod of the hydraulic member relative to a cylinder housing of the hydraulic member.
